(19) United States
(12) Patent Application Publication
(10) Pub. No.: US 2023/0029316 A1
(43) Pub. Date: Jan. 26, 2023

(54) FIBER LASER FREQUENCY TUNING WITH INTRACAVITY SPECTRAL FILTER

(71) Applicant: University of Georgia Research Foundation, Inc., Athens, GA (US)

(72) Inventors: Melanie A.R. Reber, Athens, GA (US); Nicholas D. Cooper, Athens, GA (US)

(73) Assignee: University of Georgia Research Foundation, Inc., Athens, GA (US)

(21) Appl. No.: 17/871,763

(22) Filed: Jul. 22, 2022

Related U.S. Application Data
(60) Provisional application No. 63/225,263, filed on Jul. 23, 2021.

(51) Int. Cl. H01S 3/11; H01S 3/00

(52) U.S. Cl. CPC H01S 3/1118; H01S 3/0057; H01S 3/0078

(57) ABSTRACT

Apparatus include a mode-locked laser cavity configured to produce a mode-locked output beam, wherein the laser cavity includes a gain medium situated in the laser cavity and an intracavity optical coating filter situated in the laser cavity to receive an intracavity beam, wherein the intracavity optical coating filter has an attenuation profile configured to suppress laser oscillation over a selected portion of the gain bandwidth of the gain medium and to increase a bandwidth of the mode-locked output beam based on the suppression. Related optical coatings are disclosed. Methods of arranging coatings and reducing pulse duration are also disclosed.

### CROSS REFERENCE TO RELATED APPLICATION

This application claims priority to U.S. Provisional Patent Application. No. 63/225,263, filed Jul. 23, 2021, and is incorporated by reference herein.

### ACKNOWLEDGMENT OF GOVERNMENT SUPPORT

This invention was made with government support under DESC0020268 awarded by the Department of Energy. The government has certain rights in the invention.

### FIELD

The field is laser systems with short pulse durations.

### BACKGROUND

Fiber lasers are flexible and versatile systems for the formation of ultrashort broadband pulses, precision CW lasers, and stabilized soliton pulses. Ytterbium-doped fiber can be useful as a gain medium given the broad, 100-150 nm, gain bandwidth, and small quantum defect for efficient pumping. Even though the gain bandwidth is roughly a quarter of that of a Ti:Sapphire laser, the large gain bandwidth makes it an attractive source of both ultrafast radiation and tunable continuous-wave (CW) radiation. There are multiple ways in which the spectrum of the ytterbium fiber lasers needs to be controlled or manipulated depending upon the purpose of the laser. Unfortunately, current approaches to controlling and manipulating spectra are often elaborate or cumbersome or, as with mode-locked fiber lasers, cause degradation of pulse output or cause the disabling of modelocking capability. Thus, a need remains for improved spectral controls for mode-locked based systems.

### SUMMARY

According to an aspect of the disclosed technology, apparatus include a mode-locked laser cavity configured to produce a mode-locked output beam, wherein the laser cavity includes a gain medium situated in the laser cavity and an intracavity optical coating filter situated in the laser cavity to receive an intracavity beam, wherein the intracavity optical coating filter has an attenuation profile configured to suppress laser oscillation over a selected portion of the gain bandwidth of the gain medium and to increase a bandwidth of the mode-locked output beam based on the suppression. In some examples, the increased bandwidth comprises a spectral range overlapping a spectral range of the attenuation profile and a spectral range that is not present in the mode-locked output beam in the absence the optical coating filter. In some examples, the attenuation profile comprises a cutoff frequency at a frequency position within the gain bandwidth and a filter band edge situated outside the gain bandwidth. In some examples, the frequency position comprises a position selected in relation to a gain peak of the gain bandwidth. In some examples, the attenuation profile comprises a longpass profile and in other examples the attenuation profile comprises a shortpass profile. In some examples, the intracavity optical coating filter comprises an anti-reflection coating situated on an optical surface of a selected intracavity optical component. In some examples, the intracavity optical coating filter comprises a coated transmissive substrate. Some examples further include a stage coupled to the intracavity optical coating filter or another intracavity optical component, wherein the stage is configured to change an incidence angle between the intracavity beam and the intracavity optical filter, wherein the change in incidence angle is configured to vary a cutoff frequency of the attenuation profile and a shape of the bandwidth of the mode-locked output beam based on the variation in the cutoff frequency. Some examples further include an intracavity optical filter selection unit configured to position the intracavity optical filter in the path of the intracavity beam, remove the intracavity optical filter from the path of the intracavity beam, and to position at least one other intracavity optical filter having a different attenuation profile in the path of the intracavity beam. In some examples, the mode-locked laser cavity comprises a SESAM, NPE, or another saturable absorber. In some examples, the mode-locked laser cavity comprises mode-locked fiber laser. In some examples, the mode-locked laser cavity is arranged in a linear, ring, or sigma configuration. Some examples further include a pulse compressor situated to receive the mode-locked output beam and to produce a mode-locked system beam having a shorter pulse duration than a mode-locked system beam produced without the optical coating filter based on the increased bandwidth of the mode-locked output beam. In some examples, the shorter pulse duration is at least 10% shorter relative to the pulse duration of the mode-locked system beam produced without the optical coating filter. In some examples, the shorter pulse duration is at least 20% shorter relative to the pulse duration of the mode-locked system beam produced without the optical coating filter.

Some examples include pulse compressors that can include one or more amplification stages. In some examples, the attenuation profile comprises a cutoff frequency situated substantially within the gain bandwidth. In some examples, the optical coating filter is situated to receive the intracavity beam in the cavity at a position where the wavelengths of the of the intracavity beam are uniformly spread across the spatial cross-section of the intracavity beam.

According to another aspect of the disclosed technology, methods include arranging an intracavity optical coating in a mode-locked laser cavity configured to produce a mode-locked laser cavity output beam using at least a gain medium situated in the mode-locked laser cavity, wherein the intracavity optical coating is situated to receive an intracavity beam and has an attenuation profile configured to suppress laser oscillation over a selected portion of a gain bandwidth of the gain medium and to increase a bandwidth of the mode-locked laser cavity output beam based on the suppression.

According to a further aspect of the disclosed technology, methods include reducing a pulse duration of mode-locked laser pulses output from a pulse compressor coupled to a mode-locked laser cavity by directing intracavity mode-locked laser pulses to an intracavity optical coating before being amplified and compressed with the pulse compressor, wherein the optical coating has a spectral attenuation profile overlapping a substantial portion of a gain bandwidth of a gain medium of the mode-locked laser cavity thereby causing an increase in the spectral bandwidth of the pulses output from the mode-locked laser cavity.

According to another aspect of the disclosed technology, apparatus include an optical coating having a spectral attenuation profile configured to overlap a portion, such as a substantial portion, of a gain bandwidth of a gain medium of a mode-locked laser cavity, wherein the profile is configured to cause an increase in a spectral bandwidth of pulses output from the mode-locked laser cavity. Some examples include mode-locked lasers that include one or more disclosed optical coatings, and such coatings can have any of the profiles disclosed herein.

According to a further aspect of the disclosed technology, methods include forming any of the optical coatings described herein on an optical substrate.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a schematic of a mode-locked laser system.

FIG. 2 is a schematic of a hybrid free-space and Yb:fiber oscillator mode-locked laser cavity.

FIGS. 3A-3B are laser output spectra for a longpass filter arranged inside and outside a mode-locked cavity, respectively.

FIGS. 4A-4B are laser output spectra for a shortpass filter arranged inside and outside a mode-locked cavity, respectively.

FIGS. 5A-5B are graphs of relative intensity noise for longpass and shortpass filters, respectively.

FIG. 6A is a graph of frequency-resolved optical gating pulse measurement for a compressed mode-locked laser pulse.

FIG. 6B is a graph of pulse duration of a compressed mode-locked laser pulse.

FIG. 7A-7D are graphs of example attenuation profiles in relation to hypothetical gain spectra.

FIG. 8 is a flowchart of an example method of increasing mode-locked output pulse bandwidth, and optionally reducing amplified and compressed pulse duration.

### DETAILED DESCRIPTION

To produce a shorter pulse duration through pulse compression, the spectra of the pulses emitted from the mode-locked laser cavity should have a broad spectrum. However, the output spectra of different mode-locked laser systems capable of producing very short pulse durations can be highly variable, with uncertainties in the output pulse spectra exhibited between different types of systems and different systems of the same type. Various approaches have been attempted to provide mode-locking, stabilization, or other system capabilities, such as an arrangement of a knife edge or aperture between dispersion gratings. However, these approaches are generally directed to narrowing spectra or to control other laser parameters to provide more desirable laser operation, and they can make mode-locking more difficult or can inhibit mode-locking entirely.

For example, when used as a source of narrow-linewidth radiation, there are several methods for tuning or controlling the wavelength. This can include the use of an intracavity bandpass filter to tune the wavelength for CW Yb-fiber lasers, for example. Pulsed lasers can also use bandpass filters to control the wavelength, as with some picosecond SESAM mode-locked polarization maintaining Yb-fiber lasers, which can provide tunable pulses from 1063.8 nm to 1013.8 nm. Other pulsed lasers have no explicit element for controlling the wavelengths. Erbium fiber lasers share many similarities with Ytterbium fiber lasers and many published Erbium fiber lasers use filters of various types to achieve wavelength tunability, such as a semiconductor saturable absorber mirror (SESAM) modelocked laser with 0.9 ps pulse duration.

Besides tuning the wavelength, there are uses for filtering elements in pulsed fiber lasers. All-normal-dispersion fiber lasers have used spectral filters as a way to control the dispersion in the laser with filters that are generally notch filters with only a few nanometers linewidth. Buckley et al. used a knife-edge between reflection gratings in a Yb:fiber oscillator as an optical filter with the goal of increasing the dispersion in the laser. They were able to find stable modelocking regions when limiting the short-wavelength side of the spectrum but reported difficulty in modelocking with the filter blocking the long-wavelength spectral region. Limiting the spectra to control the dispersion in the laser found use in the design of all-normal-dispersion fiber lasers and usually employ notch filters to limit the bandwidth. There are other uses of optical filters in Yb-fiber laser cavities, including narrowing the gain bandwidth to benefit dissipative soliton formation.

Another reason to control the wavelength of a laser pulse is to limit gain narrowing during amplification. Gain narrowing is the phenomenon whereby the optical spectra narrows after amplification due to the Yb gain bandwidth, which can limit the achievable pulse duration of a compressed pulse, and therefore needs to be managed to obtain ultrashort pulses. To get around this, Chiba et al. found that modifying the spectra in such a way as to decrease the spectra near the gain bandwidth peak subsequently decreases the gain narrowing. Controlling the spectra of the beam directly out of the oscillator could be an efficient way to tune the frequency in preparation for the amplification stage.

Examples of the disclosed technology advantageously introduce one or more optical coatings situated within a mode-locked laser cavity to provide a selected spectral attenuation profile overlapping at least a portion of a gain bandwidth spectrum of the gain medium within the cavity. In accordance with various examples herein, emission wavelengths and spectra can be set based on optical coatings disposed within the optical cavity. After insertion within the cavity of the intracavity optical coating having its attenuation profile overlapping the gain bandwidth spectrum of the gain medium situated in the cavity, the bandwidth of the mode-locked laser pulses output from the cavity is substantially broader than the mode-locked output pulses that would be produced without the intracavity optical coating being present. Some example optical coatings can include thin film interference coatings having cutoff frequencies situated within the gain bandwidth spectrum. In representative examples, the broadened spectrum can overlap the filtering range of the intracavity optical filter and/or can extend to spectral regions not present in the pulses generated without the filter. Particular examples use a free-space spectral filter disposed inside the lasing cavity of an ultrafast Ytterbium (Yb) mode-locked ring fiber laser. By including the filter, the ring laser can create tunable mode-locked output pulses that both have a larger overall frequency bandwidth and that are pushed to the longer and shorter frequencies relative to the Ytterbium central lasing frequency. Significantly, laser performance metrics such as relative intensity noise and post-compression pulse duration are not adversely impacted. It is contemplated that obtainable bandwidth can be increased by 5%, 10%, 15% or more, depending upon the selected gain medium, optical coating attenuation profile, placement within the cavity, and other mode-locked laser cavity parameters. As a result of the increased laser bandwidth, pulse durations after a subsequent chirped-pulse amplification can be advantageously decreased by various amounts in different examples, such as 5%, 10%, 15%, or more.

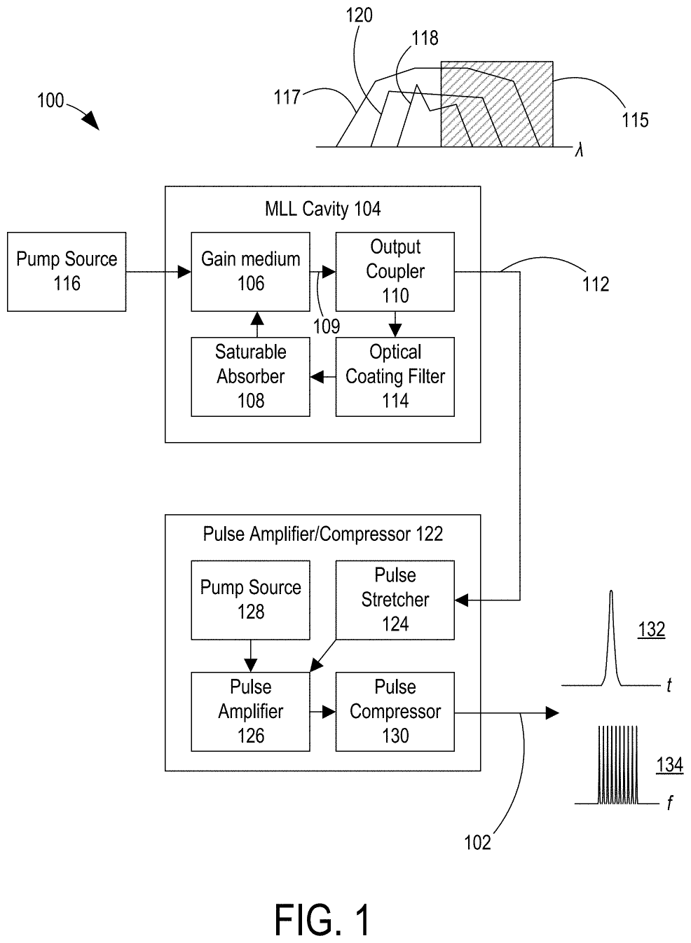

FIG. 1 is an example mode-locked laser system 100 configured to generate a beam of amplified mode-locked output pulses 102. The laser system 100 includes a mode-locked laser cavity 104. Various mode-locked laser cavity topologies may be used, which can determine various types of different optical components used to support oscillation and the mode-locking within the cavity, such as mirrors, gratings, isolators, circulators, prisms, waveplates, multiplexers, beam-splitters, polarization components, etc. Example cavity configurations can include linear, ring, sigma, as well as various modified topologies. Convenient configurations can include self-similar lasers, SESAM mode-locked cavities, passively mode-locked lasers, including passively mode-locked lasers using nonlinear-polarization rotation, etc. In some examples, bi-directional lasing can be achieved. Some cavities can be configured as all-normal-dispersion (ANDi) mode-locked laser cavities, e.g., by using filters to limit noise but also broaden output spectra. Cavity designs can be configured as all-fiber in some examples, e.g., with free-space propagation limited to some in-line fiber components. Filters in all-fiber designs can include filters configured with controllable liquid crystals to vary attenuation profile. In typical examples, the cavity 104 can include a gain medium 106, a saturable absorber 108 configured to mode-lock and generate pulses 109 within the cavity 104, and an output coupler 110 configured to allow mode-locked output pulses 112 to be directed out of the cavity 104.

The gain medium 106 can include various types of rare earth dopants, such as such as Ytterbium (Yb), Erbium (Er), Thulium (Tm), praseodymium (Pr), Holmium (Ho), Cerium (Ce), etc. The gain medium 106 can include various host materials, such as yttrium-aluminum-garnet (YAG), vanadates such as YVO₄, as well as other materials and elements including transition metals. The gain medium 106 can include solid state blocks, rods, optical fibers, etc. Yb and Er doped optical fibers can be convenient for mode-locked laser examples. Ho-YAG can be suitable in bulk material based mode-locked laser examples, such as a solid-state block. The saturable absorber 108 can be of various forms, including artificial-type saturable absorbers and absorption-based saturable absorbers. For example, saturable absorbers can include those with polarization components providing nonlinear polarization evolution (NPE), with a semiconductor saturable absorber mirror (SESAM), with a Kerr lens, or other saturable absorbers. The output coupler 110 can be in various forms such as a polarizing beam splitter.

In representative examples, the cavity 104 includes an optical coating filter 114 situated to receive the pulses 109 of an intracavity beam generated within the cavity 104. The optical coating filter 114 can be arranged at various positions in the cavity 104, including on existing cavity optics, such as lenses, mirrors, etc. The placement is generally not at a beam path position immediately before or on the output coupler 110. In typical examples, the optical coating filter 114 is placed at a beam path position that has less frequency dependence across the spatial cross-section of the beam, such as away from a Fourier plane. In representative examples, the optical coating filter 114 can be positioned where the wavelengths of the intracavity beam are uniformly spread across the spatial cross-section of the beam (with the beam having a Gaussian or other intensity distribution), e.g., at a collimated beam position. By using the optical coating filter 114 at a selected position, attenuation can be obtained while avoiding diffraction at surfaces, edges, or transmissive variations across the beam cross-section that can be associated with frequency spatial frequency filters, and the attendant adverse effects on the mode-locked output pulses 102 associated with such diffraction. The optical coating filter 114 can include one or more thin dielectric layers arranged on a substrate. Coating examples can include anti-reflective coatings, high-reflection coatings, or other thin film dielectric coatings. Substrates on which coating layers are situated can include transmissive substrates and reflective substrates. Suitable substrates can include various optical components already disposed in the cavity 104 or one or more separate optical components or substrates. Example filters can be made in various ways, such as through chemical or physical deposition processes.

The optical coating filter 114 has a selected attenuation profile 115 that substantially attenuates a selected spectral range that extends over a substantial portion of a gain bandwidth 117 of the gain medium 106. Substantial portions of the gain bandwidth 117 can include 20% of a FWHM, 30%, 40%, 50%, 60%, 70%, or larger in some instances. In some examples, the profile 115 can define a short-pass profile (e.g., as shown in FIG. 1). Some examples can provide a long-pass profile. Some examples can provide bandpass profiles with one band edge selected with the gain bandwidth 117 and the other band edge lying substantially outside the gain bandwidth 117 (e.g., beyond a −15 dB point, or a full width at about 4% of a gain bandwidth peak height). Examples can typically include edgepass filters, which transmit above or below a cutoff without including an additional cutoff or filter edge. In representative examples, short-pass or long-pass profiles can be defined relative to a lasing centroid, gain bandwidth peak, or middle lasing or gain bandwidth position associated with the gain medium 106 and/or cavity 104, or within 2%, 5%, 10%, 15%, or 20% of such a position. Example profiles can include steep attenuation shapes and/or very low loss in selected pass ranges. In some examples, the profile 115 can include a varying degree of attenuation that can be defined in relation to the variation of gain over the gain bandwidth 117, e.g., so as to provide one or more smoother spectral portions of the output pulses 112. In some examples, the profile shape can match a shape of a portion of the gain bandwidth 117. Example attenuation profiles can be uniform or approximately uniform across the optical coating filter 114 such that each portion of the beam cross-section is exposed to a similar attenuation profile.

In many examples, attenuation profiles include high or very high transmissivities over a selected transmissive region, such as at least 75%, 80%, 90%, 95%, 99%, or higher. For example, in some shortpass filter examples transmissivities can be above 95% (or other selected amount) over a short wavelength region of the gain spectrum up to a selected cutoff wavelength, and in some longpass filter examples transmissivities can be above 95% (or other selected amount) over a long wavelength region of the gain spectrum above a selected cutoff wavelength. Example cutoff wavelengths can correspond to selected positions within the gain spectrum where transmission decreases to a selected reduced transmission position very quickly relative to wavelength (e.g., 10%/nm, 20%/nm, 50%/nm, etc.) or relative to the width of the gain spectrum (e.g., over 1%, 2%, 5%, 10%, etc., of the gain bandwidth spectrum). In some examples the cutoff wavelength can decrease to a selected reduced transmission very slowly relative to wavelength (e.g., less than 10%/nm, 5%/nm, 2%/nm, etc.) or relative to the width of the gain spectrum (e.g., over more than 10%, 20%, 50%, etc., of the gain bandwidth spectrum). Optical coating filters can be tailored with different wavelength dependent attenuation profiles by forming one or more layers of dielectric on an optical substrate, such as an optically transmissive substrate made of glass and/or other materials. Optical coating filters can be fabricated with selected attenuation profiles by simulating or modeling of attenuation outputs based on quantity, thickness, material, or other parameters of the dielectric layers and desired attenuation characteristics.

During operation, a pump source 116 coupled to the cavity 104 excites active ions of the gain medium 106. The pulses 109 are generated in the cavity 104 and propagate to various components within the cavity 104. While the direction of the pulses 109 is shown in a circular path, it will be appreciated that other directions and rearrangements can be provided, including based on different cavity topologies. In the past, the lasing range of the mode-locked laser pulses has tended not extend the entire range of the gain bandwidth 117, leaving a significant portion of the bandwidth unused. As the pulses 109 interact with the optical coating filter 114, e.g., by transmission through a coated substrate, spectral portions of the pulses 109 are attenuated. This attenuation causes lasing in the cavity 104 to occur at the more extended range of the gain bandwidth 117, including in the region of the gain bandwidth 117 that overlaps the attenuation profile 115. As shown, the profile 115 overlaps a longer wavelength portion of the gain bandwidth 117, though it will be appreciated that a shorter wavelength portion or other portions can be overlapped instead. By way of illustration, without the optical coating filter 114 situated in the cavity 104, the output pulses 112 can have a spectral profile 118. With the inclusion of the optical coating filter 114 in the cavity 104, the optical coating filter 114 provides high loss over the spectral range corresponding to the profile 115 thereby locally suppressing laser oscillation in this range. Lasing continues to be allowed on modes in the suppressed range along other portions of the cavity and lasing is also pushed into ranges of the gain bandwidth 117 that normally experience little amplification. The suppression then allows the cavity 104 to produce the output pulses 112 with a spectral profile 120. Thus, the output pulses 112 can be produced with an increased bandwidth relative to the cavity without the filter, based on the suppression provided by the optical coating filter 114.

Moreover, in representative examples, the output pulses 112 are produced with an increased bandwidth with sufficiently low phase error or other errors such that compression of the output pulses 112, e.g., into the femtosecond regime, is retained. The output pulses 112 can be directed to a pulse compressor system 122. In typical examples, the system 122 includes a pulse stretcher 124 configured to dilate the pulse duration to a length sufficient to allow a selected degree of amplification. A pulse amplifier 126, pumped by a pump source 128, can then receive the dilated pulses and can amplify the pulses. A pulse compressor 130 then receives the amplified pulses and compresses the pulses to produce the system output pulses 102. In passive mode-lock cavity examples, the compressed pulse durations, e.g., with pulse graphic 132, can be in the range of less than about 10 ps, 1 ps, 500 fs, 200 fs, 100 fs, 50 fs, 10 fs, or shorter. Active modelocking is typically associated with longer pulse durations, but disclosed examples can use the intracavity filter 114 to reduce pulse duration in actively modelocked cavities as well in some examples. In representative examples, the spectrum of the output pulses 102 is a frequency comb, e.g., as represented by graphic 134. Other pulse amplifier and/or compression systems may also be used, including commercially off-the-shelf pulse compressors or constituent amplification and/or compression system components. In some examples, the pulse compressor system 122 can be configured to provide compression of the output pulses 112 with the pulse compressor 130 but without the pulse stretcher 124, pulse amplifier 126, or pump source 128. In some of such examples, system output pulses 102 that are non-amplified can have a shorter pulse duration than amplified system output pulses. For example, non-amplified durations can be at least 2% shorter, 5% shorter, 10% shorter, or shorter, than similarly produced amplified durations. Examples using the pulse amplifier 126 can reduce the spectra of the amplified pulse, which can limit the extent to which the pulse durations are reduced with the pulse compressor 130. The non-amplified compressed pulses can be used to tune the spectra for amplification while also providing a compression improvement.

In representative examples, the attenuation profile 115 of the optical coating filter 114 is arranged as a bandpass or edgepass filter that substantially transmits the gain bandwidth above or below a selected cutoff frequency. Cutoff frequencies can be selected relative to the gain bandwidth profile 117 and tailored based on spectral broadening of the output pulses 112 associated with the inclusion of the optical filter 114 in the cavity 104. For example, cutoff frequencies can be selected to coincide with or be spaced apart from a gain bandwidth peak. For a Yb doped gain medium, a cutoff can be selected in the range of 1020 nm to about 1080 nm, 1030 nm to about 1070 nm, 1040 nm to about 1060 nm, etc. Cutoff frequencies can also be selected to shift or select an output spectrum to tune an output laser frequency. Cutoff frequencies for other gain media can be selected in relation to their respective gain bandwidth profiles. In some examples, the filter 114 can inserted and removed from the path of the intracavity beam 109, e.g., with a movement stage. In some examples, another filter with a different cutoff frequency or attenuation profile can inserted into the beam path using the movement stage or a separate movement stage. In some examples, a movement stage can be coupled to the filter 114 and configured to rotate the filter 114 to change an incidence angle of the intracavity beam 109 with respect to the filter 114 to vary a cutoff frequency of the filter 114. The movement of the filter 114 can be configured to tunably change a centroid position and/or spectral breadth of the spectral profile 120, effectively providing a way to shape the output pulses 112.

### Experimental Setup and Results

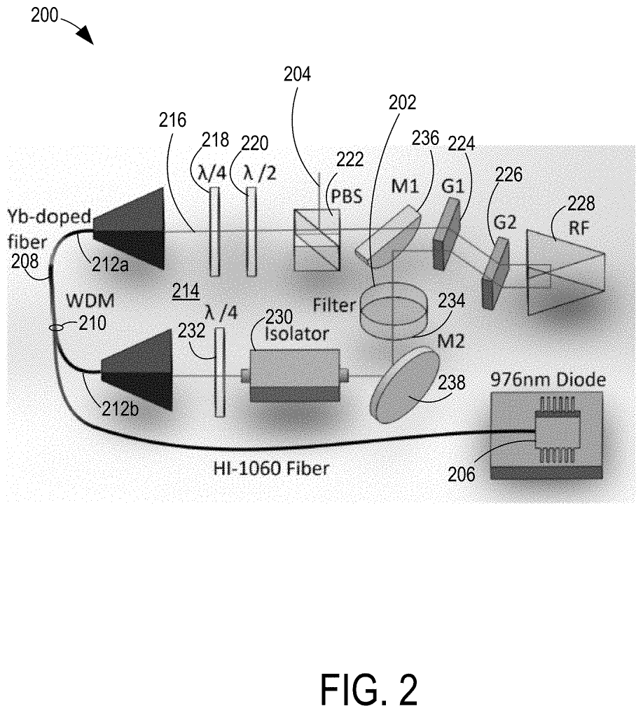

FIG. 2 is an example of a mode-locked fiber laser oscillator cavity 200 that has been recently constructed. Specific details of the components used are provided for the benefit of understanding detailed operation. It will be appreciated that examples of the technology are not limited to the specific parameters and components used in the constructed oscillator. The cavity 200 includes an intracavity spectral filter 202 configured to increase laser bandwidth in generated mode-locked output pulses 204 rather than limit the output bandwidth. The intracavity spectral filter 202 increases the bandwidth of the output pulses 204, pushing the laser cavity 200 to operate at different wavelengths. As shown, the cavity 200 is a self-similar laser arranged in a sigma layout. A 500 mW continuous-wave 976 nm diode pump source 206 is coupled to pump a core of a 25 cm section of Ytterbium-doped single-mode gain fiber 208. A wavelength-division multiplexer (WDM) 210 is situated to combine the pump light and cavity light. Sections of undoped fiber 212a, 212b are arranged on either end of the gain fiber 208 before entering a free-space region 214. An intracavity beam 216 travels through a quarter-waveplate 218 and a half-waveplate 220 followed by a polarizing beamsplitter cube 222, which serves as an output coupler. The portion of the intracavity beam 216 remaining in the cavity 200 passes through two gratings (each 600 lines/mm) 224, 226, and retroreflecting prism 228, and passes back through the gratings 224, 226. The intracavity beam 216 then goes through the intracavity optical filter 202, a Faraday rotator 230 unidirectional device, and a zero-order quarter waveplate 232 before re-entering the fiber section 212b. The half-waveplate 220 and two quarter waveplates 218, 232 along with the polarizing beamsplitter 222 are used for passive modelocking through nonlinear polarization rotation. To achieve low-noise operation, the distance between the gratings 224, 226 is set to compensate for dispersion of the fiber 208 such that the laser cavity 200 operates near net-zero dispersion.

The laser output pulses 204 were separated using a 90/10 beamsplitter for amplification and diagnostics, respectively. Diagnostics consisted of an ASEQ high resolution B-series spectrometer and a Thorlabs PDA100A2 photodetector coupled to a Stanford Research Systems FFT, a Tektronix 1.5 GHz Oscilloscope and a Rigol RF spectrum analyzer. The average power of the output pulses 204 was about 30-40 mW at an 85 MHz repetition rate. As with other polarization-modelocked fiber lasers, changing waveplate positions varies spectra and output powers for the same grating position and pump power. The spectra that were achieved were in stable and easily reproduced mode-locking regimes.

To measure a compressed pulse duration, 90% of the laser output pulses 204 was sent to a chirped-pulse amplification (CPA) system (not shown) where the pulse was amplified, compressed, and measured with a GRENOUILLE (Swamp Optics) device. The GRENOUILLE device uses a Fresnel biprism and nonlinear optics to measure short pulse durations. The amplifier was similar to the amplifier disclosed in X. Li et al., “High-power ultrafast yb:fiber laser frequency combs using commercially available components and basic fiber tools,” Rev. Sci. Instruments 87, 093114 (2016), incorporated herein by reference. The CPA system was used to show that the spectral change induced by the intracavity filter 202, including spectral broadening, resulted in a shorter pulse duration. The CPA system that was used consisted of a custom fiber-based stretcher, a large-mode-area, Yb-doped photonic crystal fiber pumped by a 40 W diode laser, and a grating pair. The amplifier is linear and the fiber stretcher has a strong cut-off at 1080 nm, which limits the bandwidth that can be sent into the compressor. Therefore, pulse durations out of the laser could likely be higher than shown below, so the durations can be considered an overestimate of achievable minimum pulse duration from the cavity 200.

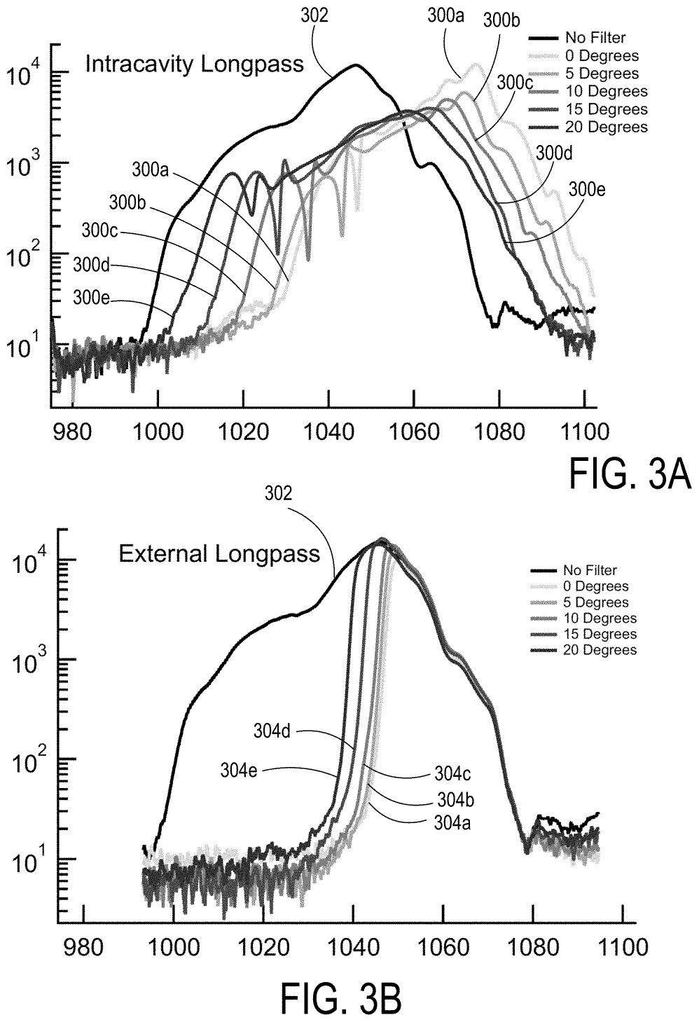

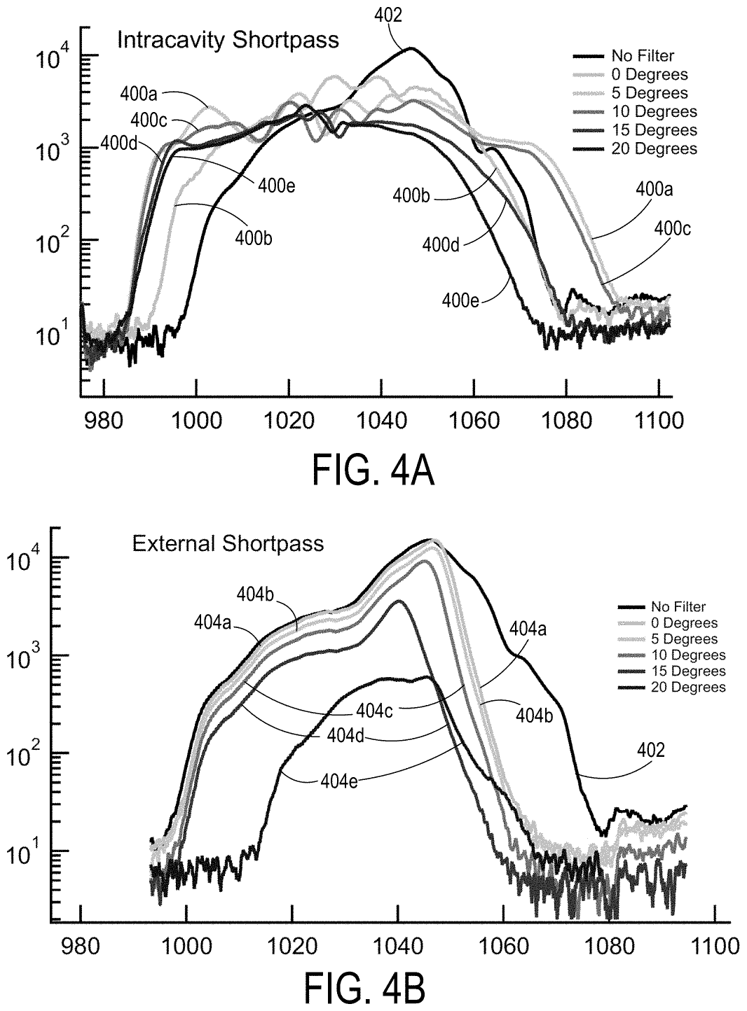

Two commercially available optical interference filters were used for the intracavity filter 202: a longpass filter (Thorlabs FELH1050) and a shortpass filter (Newport 10SWF-1050-B). The cutoff frequency of the filters was tuned slightly by changing the incident angle of the intracavity beam on the filter 202. To facilitate this, the filters were placed on a graduated rotation stage 234 between two turning mirrors 236, 238 in the laser cavity 200. The filter 202 was also placed in the path of the output beam 204 and not placed in the cavity 200 to interact with the intracavity beam 216, for comparison of spectral broadening and filtering capabilities. FIG. 3A shows representative spectra of the output pulses 204 with the longpass filter arranged as the filter 202 in the laser cavity 200 and FIG. 3B shows the spectra with the longpass filter instead placed externally to the cavity 200. FIG. 4A shows representative spectra of the output pulses 204 with the shortpass filter arranged as the filter 202 in the laser cavity 200, with FIG. 4B showing the spectra with the shortpass filter instead placed externally to the cavity 200. At zero degrees incident angle outside the cavity 200, the filters have a sharp cutoff near the specified wavelength of around 1050 nm. Increasing the incident angle shifts the cutoff frequency to the shorter wavelengths by up to 20 nm when the rotatable filter is placed inside the cavity 200 and by about 5 nm when placed externally. The shift in cutoff frequency with incident angle is consistent with the filter specifications when placed externally. When placed inside the laser cavity 200, the shift is much greater due to the complex gain dynamics of the cavity 200.

With the filter 202 inserted in the cavity 200, modelocking was reacquired while minimizing adjustments to the waveplates 218, 220, 232 and other cavity optics in order to minimize the spectral change from a new modelocking position and thereby isolate the effect of the intracavity filter 202. Modelocking was achieved with either the longpass or shortpass filter in the cavity 200, with various incidence angles on the filter from 0 to 20 degrees. By achieving modelocking over the range, some tunability of the filter cutoff wavelength was allowed. Further tuning of the angle caused a significant decrease in transmission of the filter. FIG. 3A and FIG. 4A show laser spectra 300a-300e, 400a-400e obtained for the output pulses 204 with the respective longpass and shortpass intracavity filters arranged at incidence angles 0, 5, 10, 15, and 20 degrees, respectively. Also shown are spectra 302, 402 corresponding to operation with no filter 202 placed in the cavity 200. As clearly shown, inclusion of the filter 202 inside the cavity 200 produced a spectral broadening and a shift of the lasing spectral centroid. Most notably, the laser shifts to new frequencies not seen in the spectra 302, 402 without the intracavity filter 202. It may also be noted that even though the filter 202 produces a sharp cutoff when placed outside the cavity 200, the output pulses 204 contain a significant amount of laser light beyond the filter cutoff when the filter 202 is placed intracavity. The combination of the extension of light outside the original lasing bandwidth and the light beyond the cutoff frequency of the filter corresponded to a spectral broadening, with the possibility of spectra broader than the unfiltered laser spectra. Turning the filters, which changes the angle of incidence of the intracavity beam 216 on the filter 202, shifted the cutoff frequency to shorter wavelengths for both the longpass and shortpass filter. To quantify the bandwidth at each filter position the full width at the −15 dB point was found, or the full width at about 4% of the peak height. Without the filter in place, the −15 dB full width was 65 nm. Insertion of the longpass filter initially decreased the optical bandwidth to about 58 nm and then as the filter cutoff frequency was tuned to shorter wavelengths, the bandwidth of the output pulses 204 increased to about 70 nm before the angle becomes too steep such that the filter 202 becomes very lossy and modelocking of the cavity 200 stops. Even with the expected variations in spectra with different modelocking positions on different days, these numbers were reproducible within about 2 nm.

The insertion of the intracavity shortpass filter for the filter 202 produced similar results. The most notable difference being that the spectra of the output pulses 204 was not pushed as far to longer wavelengths. This difference may be attributable to the presence of the secondary Yb absorption peak at shorter wavelengths (e.g., 976 nm).

For example, the filter 202 arranged to pass shorter wavelengths can push lasing into the spectral range of the secondary absorption peak and thereby cause reabsorption and reduced lasing. The broadest spectral bandwidth was achieved at an intermediate turning angle rather than the shortest wavelength filter cutoff. Using the full width at −15 dB (4%) height as the bandwidth metric, the spectra of the output pulses 204 had 65 nm width without the filter 202 and had about a 98 nm width with the filter 202 tuned to 5 degrees from normal incidence. Further tuning of the filter causes the bandwidth to decrease, reaching 78 nm at 20 degrees. The exact widths of the spectra changed with modelocking position, but the trends were consistent across the different modelocking regimes and various spectra.

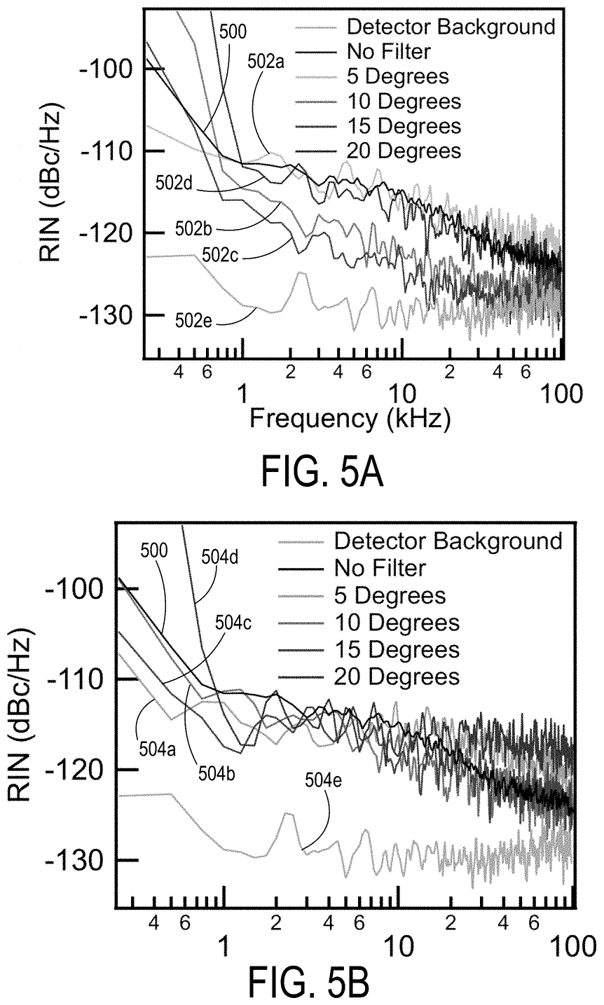

The effects of the intracavity filter on the relative intensity noise (RIN) of the laser were also investigated. The RIN was recorded with the Stanford Research Systems FFT and a low-noise home-built photodiode detector. Work by Nugent-Glandorf et al. on RIN on modelocked Yb:fiber lasers showed that the lowest noise was around zero net cavity dispersion and the RIN increased as the laser moved into the normal (or anomalous) regime. FIGS. 5A-5B show sample RIN data for the laser with no filter 500, with the longpass filter at 5, 10, 15, and 20 degree angles 502a-502d, and with the shortpass filter at 5, 10, 15, and 20 degree angles 504a-504d. Detector background data 502e, 504e are also shown. Prior to inserting the filter 202, the laser cavity 200 was configured to a slightly anomalous dispersion regime and not adjusted upon placing the filter 202 in the cavity 200. The RIN changed only slightly with use of the filter 202 and upon tuning of the filter 202, thus illustrating that low noise operation of the laser cavity 200 is not disrupted by use of the filter 202.

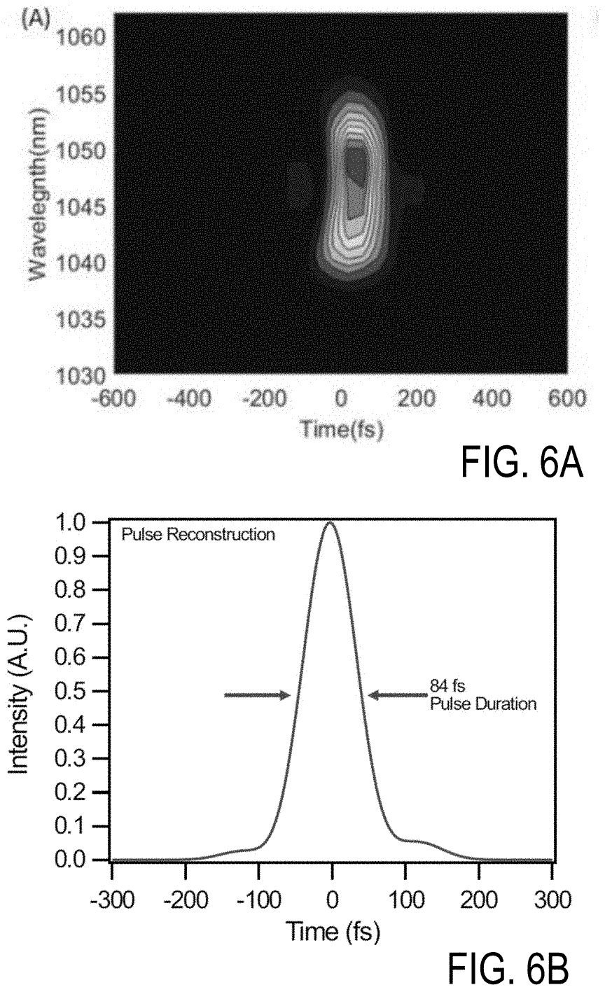

For the cavity 200 without the filter 202, after amplification in the Yb fiber 208 and then compression with the CPA system, pulse widths were obtained as low as 98 fs. After inclusion of the filter 202, either shortpass or longpass, the overall bandwidth of the output pulses 204 increased which consequently dropped the minimum pulse duration after compression to near 80 fs. Example characteristics of the obtained shortened pulses are shown in FIGS. 6A-6B. More success minimizing the pulse widths was obtained using the longpass filter for the filter 202, as it pushes the output laser pulse further red and avoids losses induced by the pulse stretcher. Shorter pulse durations can be achieved with other pulse compressors that do not limit input bandwidth. While other methods exist to dropping compressed pulse durations from pure Yb:fiber systems to between 20 and 65 fs, the inclusion of the optical filter and associated pulse duration reduction represents a simple and inexpensive alternative extension to a mode-locked laser system that requires very little expansion or reconfiguring of the cavity components. Thus, the inclusion of an edgepass filter enabled both tuning and broadening of the optical spectra of the modelocked Yb:fiber laser. The filter 202 can decrease the optical spectra, but it also can greatly broaden the optical spectra. This broadened optical spectra can still be compressed into an ultrashort pulse while maintaining the low noise performance of the laser without the optical filter. In this way, shorter pulses were obtained directly out of a Yb:fiber laser.

### Additional Examples

As discussed above, attenuation profiles for optical coating filters can be configured with various shapes and transmission/loss variations in relation to the gain bandwidth spectrum of a gain medium of a mode-locked laser cavity. The profile can be selected with a cutoff frequency situated within the gain bandwidth spectrum such that the optical coating filter is substantially transmissive over a substantial portion of the gain bandwidth spectrum. In representative examples, attenuation profiles are tailored in relation to the gain bandwidth spectrum to produce a broader spectrum in the mode-locked output pulses than would be present without the optical coating filter. In some examples, attenuation profiles are selected to tune the frequency of the mode-locked output pulses without significantly reducing bandwidth.

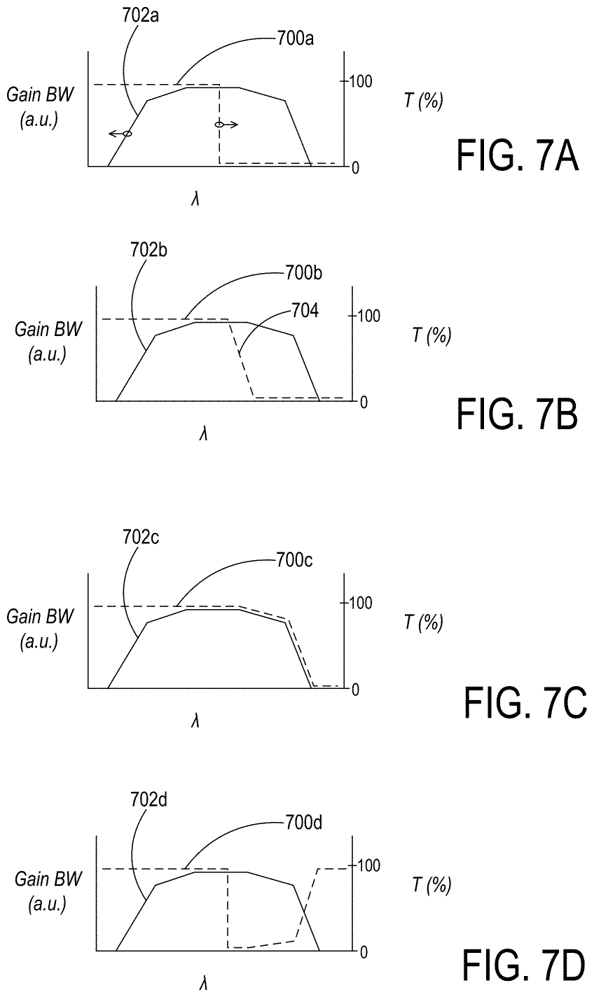

FIGS. 7A-7D show example shortpass attenuation profiles 700a-700d overlapping respective gain bandwidth spectra 702a-702d for a laser active medium. It will be appreciated that similar profiles can be provided in opposite, longpass configurations. Profile 700a is substantially transmissive over a substantial portion of the gain spectrum 702a corresponding to a shorter wavelength region. At a cutoff frequency situated in a middle region of the gain spectrum 702a, the transmissivity of the profile 700a decreases steeply to low transmissivity across a region corresponding to the remainder of a longer wavelength region of the gain spectrum 702a. Profile 700b includes a similar shorter wavelength transmissive region up to a similar cutoff frequency as profile 700a, and further includes a slowly tapering region 704 over which the transmissivity decreases more slowly than the steep cutoff of profile 700a. Profile 700c includes a substantially transmissive region over the shorter wavelengths. As the gain profile of the gain spectrum 702c begins to decrease in a longer wavelength region, the transmissivity of the profile 700c decreases with a similar contour. Profile 700d includes a transmissive region and cutoff similar to the profile 700a, though other cutoff profiles may be used, such as the slower tapering of profile 700b. Profile 700d further includes a profile segment in the longer wavelength region configured to match an inverted contour of the gain spectrum 702d. In further profile examples, attenuation regions can be provided with different attenuation amounts to experimentally determine profiles that extend or maximize mode-locked pulse output bandwidth for a selected set of laser parameters including topology, gain medium, etc.

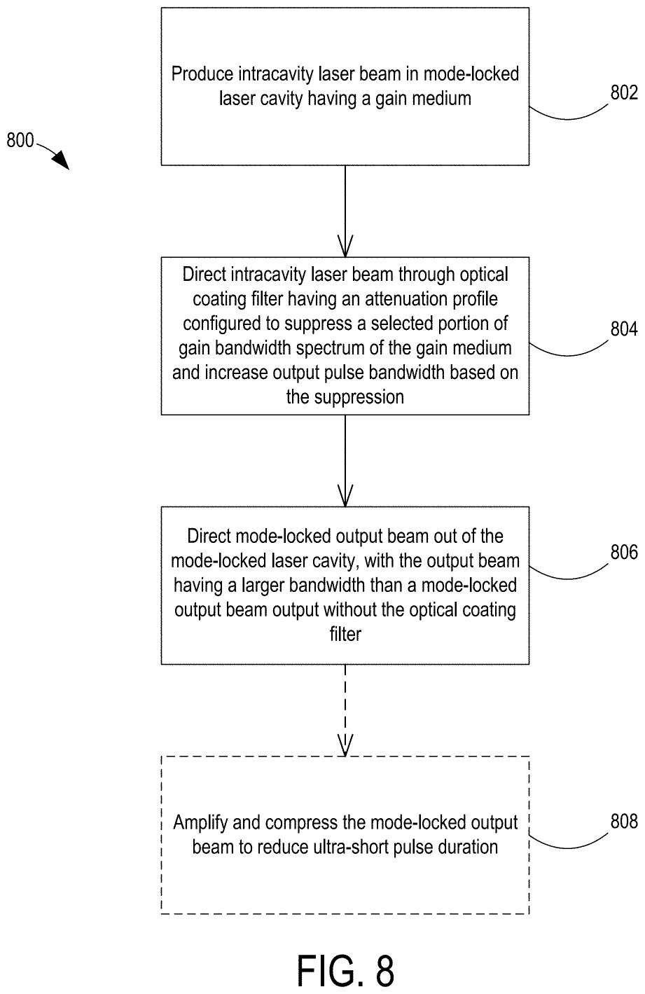

FIG. 8 shows an example method 800 of increasing the mode-locked output pulse bandwidth of a mode-locked laser. At 802, an intracavity mode-locked laser beam is produced in a mode-locked laser cavity having a gain medium. At 804, the intracavity laser beam is directed through an optical coating filter having a spectral attenuation profile configured to suppress a selected portion of the gain bandwidth spectrum of the gain medium. The profile can include a cutoff frequency situated within the gain bandwidth spectrum, e.g., in a shortpass or longpass configuration. With the optical coating filter situated in the beam path, typically at a position where the wavelengths of the intracavity beam are uniformly present across the cross-section of the beam, lasing can occur in both the substantially transmissive regions as well as the substantially attenuated regions, thereby increasing a bandwidth of the mode-locked pulses output from the cavity at 806. In some examples the increased-bandwidth output pulses can be used directly in various applications. In further examples, at 808, the increased-bandwidth output pulses can be directed to a pulse compressor that can amplify and compress the increased-bandwidth output pulses to produce ultra-short pulses, e.g., in the femtosecond range. The length of the pulse durations of the ultra-short pulses can be reduced in relation to the increase of the bandwidth in the increased-bandwidth output pulses.

### Selected Applications

Disclosed filters and mode-locked cavities can be used to broaden laser spectra. For ultrafast lasers, the broadened laser spectra can allow for shorter pulse durations. Optical filters can be tailored to the different gain media and cavity configurations to produce further reductions in pulse duration. For example, commercially available fiber lasers are typically limited to pulse durations of approximately 300 fs. Experimental results described herein demonstrated routine pulse durations as short as 100 fs, and filter enhancements reducing the pulse durations to 75 fs. Because the experimental results were limited by the measurement setup, further reductions in pulse duration can be obtained with alternative compressors applied to the same cavity, e.g., 50 fs or lower. For example, 20 fs sources can be modified by using the disclosed filters or filtering techniques to reduce pulse duration, e.g., down to 10 fs. Applications can include fundamental science research, communications (e.g., Erbium doped media in fiber communications or in free-space laser communications), defense or weapons, surgery, or industrial applications such as laser cutting, via hole drilling, etc. Another application of the disclosed technology includes tuning a modelocked laser frequency without significantly decreasing bandwidth (in wavelength). This can be useful for amplification or wavelength conversion applications where overlap in frequencies between the laser and subsequent optical components can be important. Further applications can include spectroscopic or quantum computing applications, e.g., where fs frequency combs are desired.

### General Considerations

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems, apparatus, and methods described herein should not be construed as limiting in any way. Instead, the present disclosure is directed toward all novel and non-obvious features and aspects of the various disclosed embodiments, alone and in various combinations and sub-combinations with one another. The disclosed systems, methods, and apparatus are not limited to any specific aspect or feature or combinations thereof, nor do the disclosed systems, methods, and apparatus require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

In some examples, values, procedures, or apparatus' are referred to as “lowest”, “best”, “minimum,” or the like. It will be appreciated that such descriptions are intended to indicate that a selection among many used functional alternatives can be made, and such selections need not be better, smaller, or otherwise preferable to other selections.

In view of the many possible embodiments to which the principles of the disclosed technology may be applied, it should be recognized that the illustrated embodiments are only representative examples and should not be taken as limiting the scope of the disclosure. Alternatives specifically addressed in these sections are merely exemplary and do not constitute all possible alternatives to the embodiments described herein. For instance, various components of systems described herein may be combined in function and use. We therefore claim all that comes within the scope of the appended claims.

We claim:

1. An apparatus, comprising:
a mode-locked laser cavity configured to produce a mode-locked output beam, wherein the laser cavity includes a gain medium situated in the laser cavity and an intracavity optical coating filter situated in the laser cavity to receive an intracavity beam, wherein the intracavity optical coating filter has an attenuation profile configured to suppress laser oscillation over a selected portion of a gain bandwidth of the gain medium and to increase a bandwidth of the mode-locked output beam based on the suppression.

2. The apparatus of claim 1, wherein the increased bandwidth comprises a spectral range overlapping a spectral range of the attenuation profile and a spectral range that is not present in the mode-locked output beam in the absence the optical coating filter.

3. The apparatus of claim 1, wherein the attenuation profile comprises a cutoff frequency at a frequency position within the gain bandwidth and a filter band edge situated outside the gain bandwidth.

4. The apparatus of claim 3, wherein the frequency position comprises a position selected in relation to a gain peak of the gain bandwidth.

5. The apparatus of claim 1, wherein the attenuation profile comprises a longpass profile.

6. The apparatus of claim 1, wherein the attenuation profile comprises a shortpass profile.

7. The apparatus of claim 1, wherein the intracavity optical coating filter comprises an anti-reflection coating situated on an optical surface of a selected intracavity optical component.

8. The apparatus of claim 1, wherein the intracavity optical coating filter comprises a coated transmissive substrate.

9. The apparatus of claim 1, further comprising a stage coupled to the intracavity optical coating filter or another intracavity optical component, wherein the stage is configured to change an incidence angle between the intracavity beam and the intracavity optical coating filter, wherein the change in incidence angle is configured to vary a cutoff frequency of the attenuation profile and a shape of the bandwidth of the mode-locked output beam based on the variation in the cutoff frequency.

10. The apparatus of claim 1, further comprising an intracavity optical coating filter selection unit configured to position the intracavity optical coating filter in a path of the intracavity beam, remove the intracavity optical coating filter from the path of the intracavity beam, and to position at least one other intracavity optical coating filter having a different attenuation profile in the path of the intracavity beam.

11. The apparatus of claim 1, wherein the mode-locked laser cavity comprises a SESAM, NPE, or another saturable absorber.

12. The apparatus of claim 1, wherein the mode-locked laser cavity comprises mode-locked fiber laser.

13. The apparatus of claim 1, wherein the mode-locked laser cavity is arranged in a linear, ring, or sigma configuration.

14. The apparatus of claim 1, further comprising a pulse compressor situated to receive the mode-locked output beam and to produce a compressed mode-locked system beam, wherein the optical coating filter is configured to reduce pulse duration of the compressed mode-locked system beam relative to a compressed mode-locked system beam produced without the optical coating filter, based on the increased bandwidth of the mode-locked output beam.

15. The apparatus of claim 14, wherein the optical coating filter is configured to reduce the pulse duration by at least 10% relative to the pulse duration of the mode-locked system beam produced without the optical coating filter.

16. The apparatus of claim 14, wherein the pulse compressor comprises an amplifier configured to amplify the wherein the shorter pulse duration is at least 20% shorter relative to the pulse duration of the mode-locked system beam produced without the optical coating filter.

17. The apparatus of claim 1, wherein the attenuation profile comprises a cutoff frequency situated substantially within the gain bandwidth.

18. The apparatus of claim 1, wherein the optical coating filter is situated to receive the intracavity beam in the cavity at a position where wavelengths of the of the intracavity beam are uniformly spread across a spatial cross-section of the intracavity beam.

19. A method, comprising:
arranging an intracavity optical coating in a mode-locked laser cavity configured to produce a mode-locked laser cavity output beam using at least a gain medium situated in the mode-locked laser cavity, wherein the intracavity optical coating is situated to receive an intracavity beam and has an attenuation profile configured to suppress laser oscillation over a selected portion of a gain bandwidth of the gain medium and to increase a bandwidth of the mode-locked laser cavity output beam based on the suppression.

20. A method, comprising:
reducing a pulse duration of mode-locked laser pulses output from a pulse compressor coupled to a mode-locked laser cavity by directing intracavity mode-locked laser pulses to an intracavity optical coating before being amplified and compressed with the pulse compressor, wherein the optical coating has a spectral attenuation profile overlapping a substantial portion of a gain bandwidth of a gain medium of the mode-locked laser cavity thereby causing an increase in a spectral bandwidth of the pulses output from the mode-locked laser cavity.

21. An apparatus, comprising:
an optical coating having a spectral attenuation profile configured to overlap a portion of a gain bandwidth of a gain medium of a mode-locked laser cavity, wherein the profile is configured to cause an increase in a spectral bandwidth of pulses output from the mode-locked laser cavity.

22. A mode-locked laser comprising the optical coating of claim 21.

23. A method, comprising forming the optical coating of claim 21 on an optical substrate.
